(19) United States
(12) Patent Application Publication
(10) Pub. No.: US 2025/0196057 A1
(43) Pub. Date: Jun. 19, 2025

(54) Reducing Energy Consumption in Nitrogen Production Using a Turboexpander

(71) Applicant: Air Products and Chemicals, Inc., Allentown, PA (US)

(72) Inventors: Christer Haugland, Kristiansand (NO); Kjetil Sindum, Bjorbekk (NO)

(73) Assignee: Air Products and Chemicals, Inc., Allentown, PA (US)

(21) Appl. No.: 18/544,850

(22) Filed: Dec. 19, 2023

(51) Int. Cl. B01D 53/22; C01B 21/04

(52) U.S. Cl. CPC B01D 53/228; C01B 21/0444; B01D 2053/221; B01D 2256/12; B01D 2257/102

(57) ABSTRACT

An air separation system using a membrane separation unit to produce a nitrogen-enriched product stream from a feed air stream is described herein. A nitrogen-enriched non-permeate stream is expanded in a turboexpander and the energy recovered during expansion is used to further compress the feed air stream prior to membrane separation. Expanded nitrogen-enriched non-permeate stream is also used to cool the compressed feed air upstream from membrane separation.

### BACKGROUND

This invention relates to a system and method for generating a nitrogen-enriched gas from a supply stream of ambient air. Compression of ambient air to form a pressurized feed air stream is one of the most energy intensive aspects of air separation. A pressurized feed air stream is required in all practical methods for separating air into its constituents to yield useful product streams such as nitrogen. Membrane separation is an example of an air separation process requiring a pressurized feed air stream. In conventional membrane-based air separation systems, where a constituent is separated from a pressurized feed air stream, the feed air stream is pressurized in one or more compression stages. In conventional membrane-type air separation systems, pressurization requires a substantial amount of energy. The driving force for separation is created by the partial pressure difference across the membrane and depends on the pressure of the feed air stream and the feed stream composition. Thus, increasing the pressure of the feed air stream as it is supplied to the membrane modules generally results in more oxygen permeating the membrane and thus an increased nitrogen purity in the product stream. This increased pressure of the feed air stream increases energy consumption requirements for the system. Additional (and/or more powerful) compressors are required to generate the increased pressure. Additional membrane modules may also be required. Additional power is required to drive the compressors.

Therefore, there is a need for an effective, reliable, and cost-efficient membrane-type air separation system that can separate a constituent, such as nitrogen, from a feed air stream while reducing energy consumption and maintaining overall capital and operating expenditures.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Several aspects of the systems and methods are outlined below.

The disclosed embodiments satisfy the need in the art by providing an air separation system wherein a supply stream of ambient air is compressed in one or several compressor units to create a pressurized feed air stream which is then further compressed within a turboexpander. The further compressed feed air stream is then separated via a polymeric membrane to produce a nitrogen-enriched stream. The nitrogen-enriched stream is then expanded within the turboexpander. The work associated with the expansion is utilized during the further compression step. Expanding the nitrogen product and using the work to further compress the feed air stream substantially reduces energy consumption of the air separation system.

Several aspects of the systems and methods are outlined below.

Aspect 1: A method for separating a nitrogen-enriched stream from a supply stream of ambient air having a feed pressure, the method comprising (a) compressing the compressing the supply stream of ambient air in a first compression stage to form a pressurized feed air stream having a first pressure that is greater than the feed pressure; (b) further compressing the pressurized feed air stream in a second compression stage to form a further compressed feed air stream having a second pressure that is greater than the first pressure; (c) separating the further compressed gas stream in a membrane stage to form a nitrogen-enriched non-permeate stream and an oxygen-enriched permeate stream; (d) expanding the nitrogen-enriched non-permeate stream in a volumetric expander to form a reduced pressure nitrogen-enriched non-permeate stream having a third pressure that is less than the second pressure; and (e) using work generated by the volumetric expander in step (d) to provide power to the second compression stage to perform step (b).

Aspect 2: The method of Aspect 1, further comprising mechanically coupling the second compression stage to the volumetric expander.

Aspect 3: The method of any of Aspects 1 through 2, further comprising: (f) cooling the further compressed feed air stream against the reduced pressure nitrogen-enriched non-permeate stream in a heat exchanger before introducing the further compressed feed air stream into the membrane stage to form a cooled further compressed feed air stream and a nitrogen-enriched product stream.

Aspect 4: The method of any of Aspects 1 through 3, further comprising: (g) filtering the compressed gas stream before performing step (b).

Aspect 5: The method of any of Aspects 1 through 4, further comprising: (h) controlling flow of the nitrogen-enriched non-permeate stream to the volumetric expander using a control valve located downstream of the membrane stage.

Aspect 6: The method of any of Aspects 1 through 5, further comprising withdrawing the nitrogen-enriched non-permeate stream as a product stream.

Aspect 7: A system comprising: a first compression stage comprising at least one compressor and being in fluid flow communication with a supply stream of ambient air at a feed pressure, the first compression stage being adapted to compress the supply stream to form a pressurized feed air stream having a first pressure that is greater than the feed pressure; a second compression stage comprising at least one compressor and being in downstream fluid flow communication with the first compressor stage, the second compression stage adapted to further compress the compressed feed air stream to form a further compressed feed air stream having a second pressure that is greater than the first pressure; an air separation unit in downstream fluid flow communication with the second compression stage, the air separation unit being arranged to separate the further compressed feed air stream into a nitrogen-enriched stream and an oxygen-enriched stream; and a volumetric expander in downstream fluid flow communication with the nitrogen-enriched stream, the volumetric expander adapted to expand the nitrogen-enriched stream to form an expanded nitrogen-enriched stream; wherein the volumetric expander is mechanically coupled to the second compression stage so that expansion of the nitrogen-enriched stream provides power to the second compression stage.

Aspect 8: The system of Aspect 7, further comprising a heat exchanger in downstream fluid flow communication with the second compression stage and upstream fluid flow communication with the membrane stage, the heat exchanger being adapted to provide indirect heat exchange between the further compressed feed air stream and the expanded nitrogen-enriched stream to form a cooled further compressed feed air stream and a nitrogen-enriched product stream.

Aspect 9: The system of any of Aspects 7 through 8, further comprising a flow control valve in downstream fluid flow communication with the nitrogen-enriched stream from the air separation unit and upstream fluid flow communication with the volumetric expander.

Aspect 10: The system of any of Aspects 7 through 9, wherein the feed pressure is between 5.0 and 11.0 barg.

Aspect 11: The system of any of Aspects 7 through 10, wherein the air separation unit comprises at least one membrane module.

Aspect 12: The system of any of Aspects 7 through 11, further comprising at least one filter in downstream fluid flow communication with the first compression stage and upstream fluid flow communication with the second compression stage.

### BRIEF DESCRIPTION OF THE DRAWING(S)

The present invention will hereinafter be described in conjunction with the appended figures wherein like numerals denote like elements.

FIG. 1 is a process flow diagram of an exemplary prior art system for separating a constituent gas as such as nitrogen from a supply stream of ambient air;

FIG. 2 is a process flow diagram of a first embodiment of the air separation system of the present invention;

FIG. 3 is a table containing performance characteristics of the prior art system for separating a constituent gas such as nitrogen from a supply stream of ambient air;

FIG. 4 is a table containing performance characteristic of the first embodiment of the air separation system of the present invention; and,

FIG. 5 is a graph illustrating the reduction in relative power consumption provided by the air separation system of the present invention compared with the exemplary air separation system of the prior art.

### DETAILED DESCRIPTION OF THE PREFERRED EMBODIMENTS

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing the exemplary embodiments of the invention, it being understood that various changes may be made in the function and arrangement of elements without departing from the spirit and scope of the invention.

To aid in describing the invention, directional terms may be used in the specification and claims to describe portions of the present invention (e.g., upper, lower, left, right, etc.). These directional terms are merely intended to assist in describing and claiming the invention and are not intended to limit the invention in any way. In addition, reference numerals that are introduced in the specification in association with a drawing figure may be repeated in one or more subsequent figures without additional description in the specification in order to provide context for other features.

In the claims, letters are used to identify claimed steps (e.g. (a), (b), and (c)). These letters are used to aid in referring to the method steps and are not intended to indicate the order in which claimed steps are performed, unless and only to the extent that such order is specifically recited in the claims.

Unless otherwise indicated, the articles “a” and “an” as used herein mean one or more when applied to any feature of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

Unless otherwise stated herein, any and all percentages identified in the specification, drawings, and claims should be understood to be on a volume percentage basis. Unless otherwise stated herein, any and all pressures identified in the specification, drawings, and claims should be understood to mean gauge pressure.

The term “membrane”, as used in the specification and claims, means an interphase between two adjacent phases acting as a selective barrier, regulating the transport of gases among gas mixtures.

The term “membrane module”, as used in the specification and claims, means a device that is used to selectively separate gases by flowing, at a relatively high pressure, a feed air through one or more conduits contained within a shell (also referred to as a high-pressure side). The conduits are at least partially defined by a membrane material that provides a barrier between each conduit and a shell space (also referred to as a low-pressure side). The shell space is an internal volume within the shell and external to each of the membranes that is maintained at a relatively low pressure. The shell side is in fluid flow communication with a permeate port, through which gas that permeates the membrane(s) exits the shell. Optionally, a sweep port may also be provided, which supplies a sweep gas to the shell space and assists the flow of permeate gas through the permeate port. The membrane material is chosen to enable one or more gases in the feed stream (referred to as the permeate gas) to pass through the membrane material at a higher rate than other gas(es) in the feed air stream (referred to as the non-permeate or product gas). The membrane module may be of a bore-side feed design wherein the membrane module is pressurized by introduction of a feed air stream into its bore side or may be of a shell-side feed design wherein the membrane module is pressurized by introduction of the feed air stream into its shell side.

Where used herein to identify recited features of a method or system, the terms “first,” “second,” “third,” and so on, are used solely to aid in referring to and distinguishing between the features in question and are not intended to indicate any specific order of the features, unless and only to the extent that such order is specifically recited.

As used herein, reference to a product stream from a gas separation process being “enriched” in a particular gas or component means that the stream has a higher volume % of said particular gas or component than the supply stream to the gas separation process. Thus, where a gaseous supply stream comprising a first gas and a second gas is being separated via a membrane separation process to provide a non-permeate stream enriched in the second gas, the non-permeate stream has a higher volume % of the second gas than the gaseous supply stream. Where the supply stream is a supply stream of ambient air and the non-permeate stream is a nitrogen-enriched product stream, the nitrogen-enriched product stream therefore has a higher volume % of nitrogen than the supply stream of ambient air.

As used herein, the term “fluid flow communication” refers to the nature of connectivity between two or more components that enables liquids, vapors, and/or two-phase mixtures to be transported between the components in a controlled fashion (i.e., without leakage) either directly or indirectly. Coupling two or more components such that they are in fluid flow communication with each other can involve any suitable method known in the art, such as with the use of welds, flanged conduits, gaskets, and bolts. Two or more components may also be coupled together via other components of the system that may separate them, for example, valves, gates, or other devices that may selectively restrict or direct fluid flow. As used herein, the term “conduit” refers to one or more structures through which fluids can be transported between two or more components of a system. For example, conduits can include pipes, ducts, passageways, and combinations thereof that transport liquids, vapors, and/or gases.

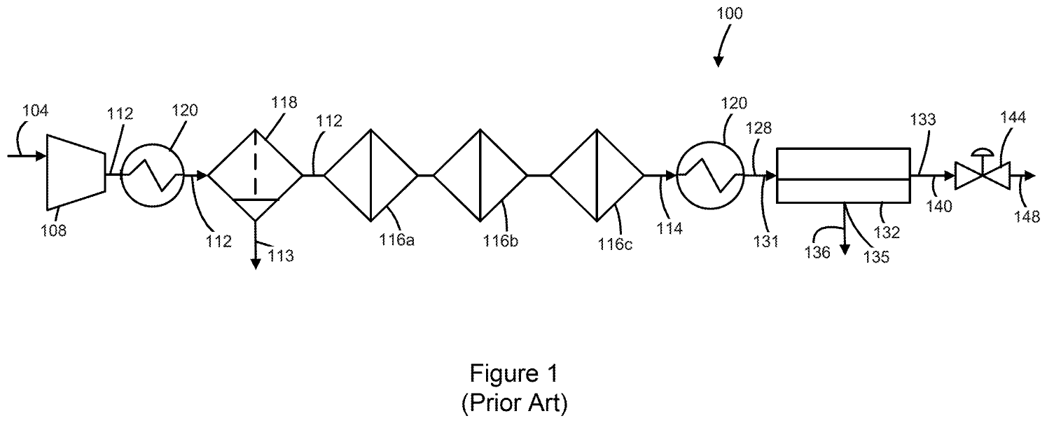

Referring now to FIG. 1, a schematic of a membrane-based air separation system 100 of the prior art is shown. A supply stream of ambient air 104 comprising nitrogen and oxygen is provided at atmospheric pressure. The supply stream 104 enters a primary compressor 108 and is compressed to form a pressurized feed air stream 112 having a pressure greater than atmospheric pressure. Alternatively, the pressurized feed air stream 112 may be supplied from sources or means other than the compressor 108. For example, the pressurized feed air stream 112 may be supplied in a pressurized form to the system 100 by a third-party or may be supplied by multiple compressors. The outlet of the primary compressor 108 may be in fluid flow communication with a heat exchanger 120 which cools the pressurized feed air stream 112 therein to ambient temperature using a suitable coolant such as fresh water, sea water, or air. The heat exchanger 120 may be in fluid flow communication with a water separator 118 provided at a location downstream from the heat exchanger 120 to remove water condensate 113 from the pressurized feed air stream 112. The water separator 118 may be in fluid flow communication with one or more filters 116a-c, e.g., coalescing or particulate filters, located downstream therefrom. Alternatively, or additionally, carbon beds may be provided for oil vapor removal.

The filters 116a-c may be provided to remove any particulates, oil droplets, fine particles, and other impurities from the pressurized feed air stream 112. For example, in system 100, three filters 116a-c may be provided in series. In other applications, a greater or fewer number of filters 116a-c may be provided and the filters 116a-c may also be arranged in parallel and/or in series to increase capacity. In other applications, filters 116a-c could be excluded entirely from the air separation system 100.

Upon exiting the filters 116a-c, the pressurized feed air stream 114 may be fed to a heat exchanger 120 in fluid flow communication with the filters 116a-c, where it is heated above the saturation point to prevent condensation from forming in the membranes of the membrane separator 132. The pressurized feed air stream 114 may be heated within the heat exchanger 120 using hot water obtained from the primary compressor 108. Alternatively, the pressurized feed air stream 114 may be heated utilizing an electric heater (not shown) or a process heater (not shown). The pressurized feed air stream 128 exiting the heat exchanger 120 then enters a membrane separator 132 at an inlet end 131 where it is separated into an oxygen-enriched permeate stream 136 and a nitrogen-enriched non-permeate stream 140. The oxygen-enriched permeate stream 136 exits the membrane separator 132 at an outlet end 135 and may comprise oxygen within a range of 21 to 50%, while the nitrogen-enriched non-permeate stream 140 exits the membrane separator 132 at an outlet end 133 and may comprise oxygen within a range of 5 to 0.1%. Alternatively, the membrane separator 132 could comprise a plurality of stages, e.g., in series. Under this arrangement, the oxygen-enriched permeate stream may comprise oxygen within a range of 0.1 to 50% at the last stage of the plurality of stages.

The membrane separator 132 may comprise a polymeric membrane(s) and may include one or more modules, arranged in series and/or in parallel. In each module, the membrane may take any suitable form, such as a bundle of hollow fibers or one or more flat or spiral wound sheets, as is well known in the art. The nitrogen-enriched non-permeate stream 140 exits the membrane separator at an outlet end 133 and may be retained as a product stream 148. The oxygen-enriched permeate stream 136 exits the membrane separator 132 at an outlet end 135 and may be vented to the atmosphere as a waste stream.

Fine control of the nitrogen purity of the nitrogen-enriched non-permeate stream 140 is typically achieved by controlling the flow rate of the nitrogen-enriched non-permeate stream 140 using a control valve 144, which affects the pressure on the non-permeate side of the membrane separator 132.

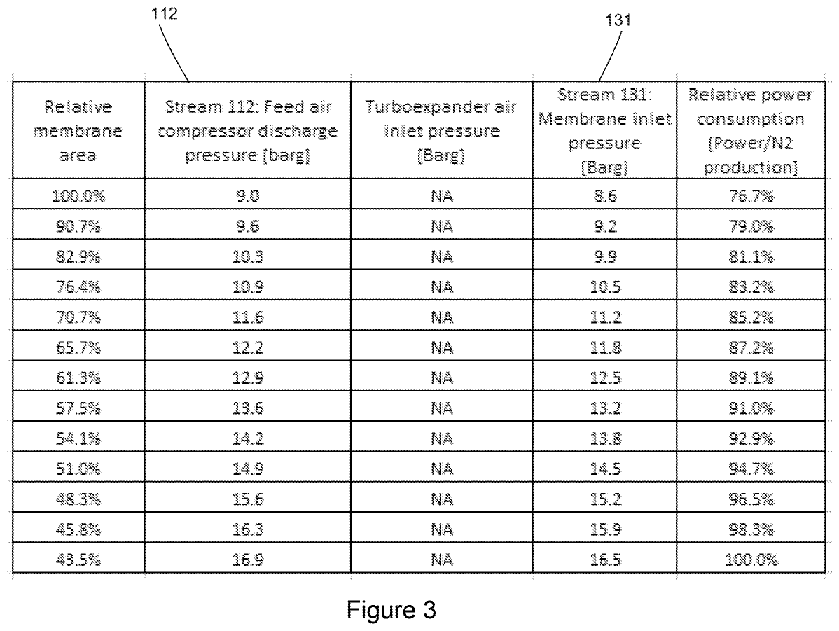

Simulations were performed using the membrane-based air separation system 100 of the prior art under conditions set forth in the table shown in FIG. 3. In each simulation, the feed air stream 128 is provided at a different pressure and the corresponding membrane area is adjusted accordingly to produce a nitrogen-enriched stream having a production and purity of 4500 Nm3/h of nitrogen-rich gas at 5 vol % O2. For each simulation, the table provides performance characteristics including relative power consumption.

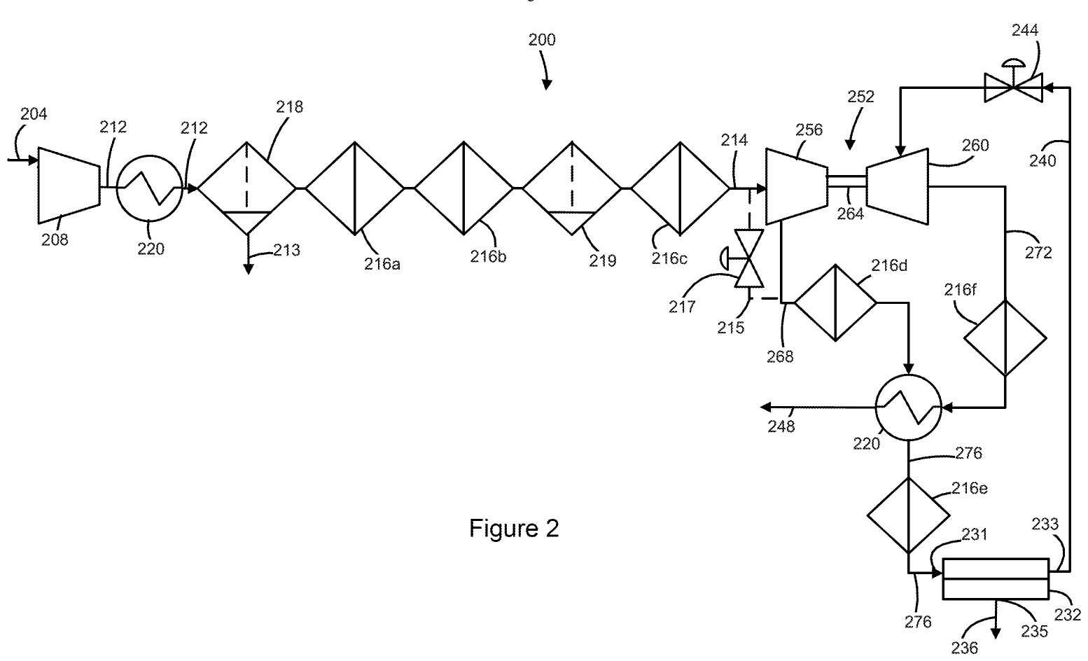

Turning now to FIG. 2, an exemplary embodiment of a membrane-based air separation system 200 of the present invention is shown. In system 200, a supply stream 204, preferably ambient air comprising nitrogen and oxygen, is provided at atmospheric pressure to the suction side of a feed compressor 208. The supply stream 204 enters the compressor 208, where it is compressed to a pressure from 2 to 40 barg, or from 6.5 to 9.5 barg, to form a pressurized feed air stream 212. Optionally, the feed compressor 208 may include ancillary equipment such as filters for removal of oil droplets and particulates, and a water separator for removing water condensate from the supply stream 204. Alternatively, the pressurized feed air stream 212 may be supplied from sources or means other than the compressor 208. For example, the pressurized feed air stream 212 may be supplied in a pressurized form to the system 200 by a third-party at a temperature from −10 to 100 degrees C., or from 0 to 60 degrees C. The outlet of the primary compressor 208 is in fluid flow communication with a heat exchanger 220, which cools the pressurized feed air stream 212 therein to 50 to 120 degrees C. using a suitable coolant such as fresh water, sea water, or air. Typically, the pressurized feed air stream 212 is cooled to about 1 to 15 degrees C. above the cooling medium temperature of the heat exchanger 220. Thus, the cooling medium temperature could be from 0 to 55 degrees C. for an air-cooled compressor and could be from 5 to 40 degrees C. for a water-cooled compressor. The outlet of the heat exchanger 220 is in fluid flow communication with a water separator 218 provided at a location downstream from the heat exchanger 220 to remove water condensate 213 from the pressurized feed air stream 212.

Filters 216a-f may be placed at suitable locations within the system 200 between the primary compressor 208 and membrane separator 232 for removal of any particulates, oil droplets, fine particles, and other impurities from the air stream. For example, the water separator 218 may be in fluid flow communication with one or more filters 216a-c, e.g., coalescing filters, provided for the purposes discussed above. For example, the system 200 may be provided with three filters 216a-c. The filters may be arranged in series and/or in parallel to increase capacity. In other applications, a different number of filters 216a-c may be provided, or the filters could be excluded entirely from the air separation system 200. Alternatively, the filters 216a-c could be positioned downstream from a boost compressor 256 along stream 268 with no filtration between the water separator 213 and the boost compressor 256.

In addition, the air separation system 200 may include a dryer 219 to prevent damage to the membrane separator 232 which may be susceptible to water damage. As best shown in FIG. 2, the dryer 219 may be positioned between filters 216b and 216c. Alternatively, the dryer 219 may be placed at any position between the water separator 218 and boost compressor 256.

Upon exiting the filters 216a-c, the pressurized feed air stream 214 is fed to a boost compressor 256 to form a further compressed feed air stream 268 having a pressure greater than the pressurized feed air stream 214. The further compressed feed air stream 268 exits the boost compressor 256 at a pressure from 3 to 100 barg and at a temperature from −30 to 100 degrees C., or from 40 to 60 degrees C. Alternatively, a bypass stream 215 may be provided to bypass the booster compressor 256 of the turboexpander 252. Optionally, a flow control valve 217 may be provided along the bypass stream 215 to control the outlet pressure. Bypassing the boost compressor 256 of the turboexpander 252 along bypass stream 215 may be required during startup of the air separation system 200.

The boost compressor 256 is mechanically linked by a common shaft 264 to a volumetric expander 260 to form a turboexpander 252. After exiting the boost compressor 256, the further compressed feed air stream 268 may be fed to one or more filters 216d optionally provided for the filtration purposes discussed above. Thereafter, the further compressed feed air stream 268 may be fed to a heat exchanger 220 for cooling to within a range of 50 to 120 degrees C. using a suitable coolant such as water to form a cooled compressed feed air stream 276 suitable for delivery to a membrane separator 232. At the inlet 231 of the membrane separator 232, the cooled compressed feed air stream 276 may be cooled using a suitable refrigerant, e.g., nitrogen, within the 50 to 120 degrees C. range provided above. Optionally, one or more additional filters 216e may be provided downstream from the heat exchanger 220 for the purposes discussed above.

The further compressed feed air stream 276 then enters the membrane separator 232 at an inlet end 231, where it is separated into an oxygen-enriched permeate stream 236 and a nitrogen-enriched non-permeate stream 240. As in system 100, the membrane separator 232 of system 200 may comprise a polymeric membrane(s) and may include one or more modules, arranged in series and/or in parallel, and in each module the membrane may take any suitable form, such as a bundle of hollow fibers or one or more flat or spiral wound sheets, as is well known in the art. The nitrogen-enriched non-permeate stream 240 may be withdrawn from the membrane separator 232 at an outlet end 233 and the oxygen-enriched permeate stream 236 may be withdrawn at an outlet end 235 and vented to the atmosphere as a waste stream. In some embodiments, a two-stage membrane may be used (not shown) and the permeate stream from the second stage may be used as a sweep gas for the permeate stream of the first stage. Fine control of the nitrogen purity of the non-permeate stream 240 is typically achieved by controlling the flow rate of the non-permeate stream 240 by using a control valve 244, the flow rate set point of the control valve being regulated by the nitrogen purity of the non-permeate stream 240.

The nitrogen-enriched non-permeate stream 240 is provided to the volumetric expander 260 of the turboexpander 252 where it is expanded to produce energy, a portion of which may be used to drive the boost compressor 256 to further compress the pressurized feed air stream 214. Upon expansion, the nitrogen-enriched non-permeate stream 240 cools to form a cooled expanded stream 272 which may be withdrawn from the turboexpander 252 and utilized further in the system to generate refrigeration at the heat exchanger 220. After expansion, the cooled expanded stream 272 is typically at a temperature from −50 to −100 degrees C. Thus, for most but not all applications, the expanded nitrogen stream 272 must be heated. The typical temperature range of the expanded nitrogen stream 272 downstream of the heat exchanger 220 will be from 20 to 35 degrees C., which is more desirable for some applications. One or more filters 216f may be provided downstream from the volumetric expander 260 for the purposes discussed above. Thereafter, the cooled expanded stream 272 passes through the heat exchanger 220 where it is heated utilizing heat obtained from the further compressed feed air stream 268 and is withdrawn as a product stream 248. Alternatively, the cooled expanded stream 272 could be heated by other sources such as air or water or may not be heated and instead be provided as a refrigerant to a customer or for use in another process. The boost compressor 256 and the volumetric expander 260 of the turboexpander 252 each may include one or more stages arranged in parallel and/or in series. The boost compressor 256 may include the same number of stages as the volumetric expander 260 or may include a different number of stages.

Work generated from expanding the nitrogen-enriched non-permeate stream 240 could alternatively be used to create a vacuum on the permeate side of the membrane separator 232. The system can alternatively have one or several vacuum pumps compressing the permeate stream of the membrane(s) to further decrease the overall energy intensity of the system. The inclusion of a vacuum pump will decrease the energy intensity of the system, but will increase the capital cost of the system.

It should be noted that, in most applications in which a nitrogen-enriched product stream is generated using one or more membranes, it may be necessary to supply the product stream at a relatively high pressure. System 200 presents an unusual situation in which the product stream 248 may be supplied at a significantly lower pressure than the pressure at which it exits the membrane. Accordingly, the turboexpander 252 enables capture of work that would otherwise be lost when dropping the pressure of the nitrogen-enriched non-permeate stream 240 to that of the product stream 248.

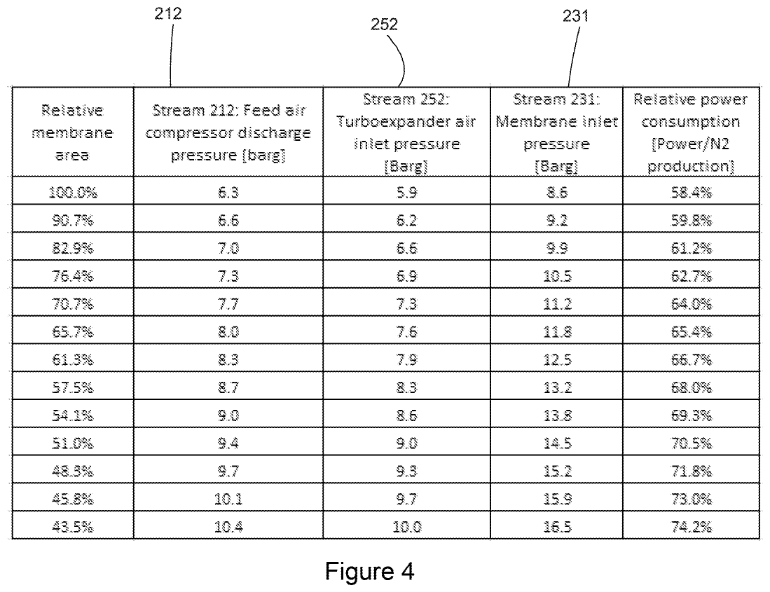

FIG. 4 shows data from simulations performed using the membrane-based air separation system 200. Each simulation includes a membrane area that corresponds to a simulation performed in FIG. 2. For each simulation, the area of the membrane within the membrane separator 232 is adjusted to produce a nitrogen-enriched non-permeate stream having the same production and purity of 4500 Nm3/h of nitrogen-rich gas at 5 vol % O2. A comparison of FIG. 4 with FIG. 3 shows that the required compression of the feed air stream is reduced and relative power consumption is reduced in the system of the present invention.

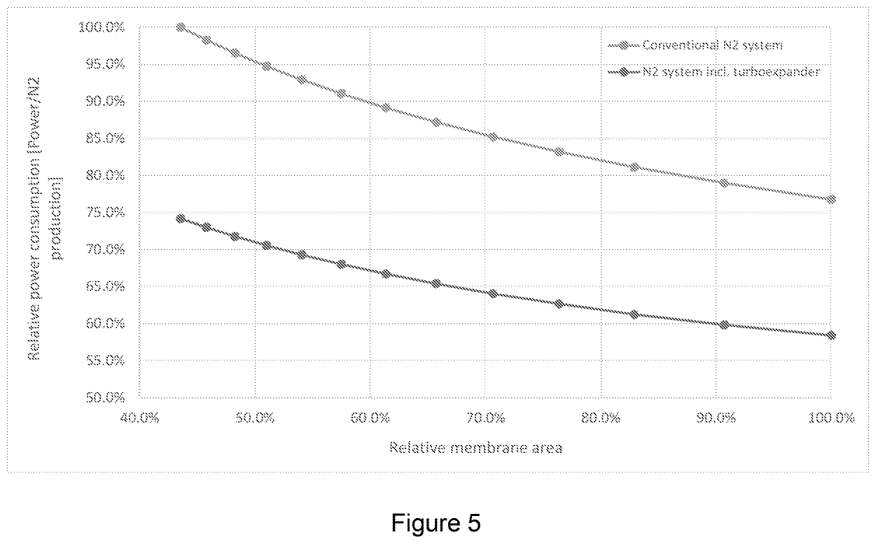

FIG. 5 illustrates in graphic form the percent reduction in relative power consumption provided by the membrane-based air separation system of the present invention 200 including the turboexpander when compared with the membrane-based air separation system 100 of the prior art for each of the multiple simulations set forth in FIGS. 3 and 4. As can be seen in FIG. 5, the relative power consumption of system 200 is substantially lower than that of system 100 for all compressed air pressures used in the simulation.

The present invention is not intended to be limited in scope by the specific aspects or embodiments disclosed in the examples herein. Instead, the aspects, embodiments, and examples are intended as illustrations of a few aspects of the invention and any embodiments that are functionally equivalent are within the scope of this invention. Various modifications of the invention in addition to those shown and described herein will become apparent to those skilled in the art and are intended to fall within the scope of the appended claims.

1. A method for separating a nitrogen-enriched stream from a supply stream of ambient air having a feed pressure, the method comprising:
(a) compressing the supply stream of ambient air in a first compression stage to form a pressurized feed air stream having a first pressure that is greater than the feed pressure;
(b) further compressing the pressurized feed air stream in a second compression stage to form a further compressed feed air stream having a second pressure that is greater than the first pressure;
(c) separating the further compressed gas stream in a membrane stage to form a nitrogen-enriched non-permeate stream and an oxygen-enriched permeate stream;
(d) expanding the nitrogen-enriched non-permeate stream in a volumetric expander to form a reduced pressure nitrogen-enriched non-permeate stream having a third pressure that is less than the second pressure; and
(e) using work generated by the volumetric expander in step (d) to provide power to the second compression stage to perform step (b).

2. The method of claim 1, further comprising mechanically coupling the second compression stage to the volumetric expander.

3. The method of claim 1, further comprising:
(f) cooling the further compressed feed air stream against the reduced pressure nitrogen-enriched non-permeate stream in a heat exchanger before introducing the further compressed feed air stream into the membrane stage to form a cooled further compressed feed air stream and a nitrogen-enriched product stream.

4. The method of claim 1, further comprising:
(g) filtering the compressed gas stream before performing step 1(b).

5. The method of claim 1, further comprising:
(h) controlling the flow of the nitrogen-enriched non-permeate stream to the volumetric expander using a control valve located downstream of the membrane stage.

6. The method of claim 1, further comprising withdrawing the nitrogen-enriched non-permeate stream as a product stream.

7. A system comprising:
a first compression stage comprising at least one compressor and being in fluid flow communication with a supply stream of ambient air at a feed pressure, the first compression stage being adapted to compress the supply stream to form a pressurized feed air stream having a first pressure that is greater than the feed pressure;
a second compression stage comprising at least one compressor and being in downstream fluid flow communication with the first compressor stage, the second compression stage adapted to further compress the compressed feed air stream to form a further compressed feed air stream having a second pressure that is greater than the first pressure;
an air separation unit in downstream fluid flow communication with the second compression stage, the air separation unit being arranged to separate the further compressed feed air stream into a nitrogen-enriched stream and an oxygen-enriched stream; and
a volumetric expander in downstream fluid flow communication with the nitrogen-enriched stream, the volumetric expander adapted to expand the nitrogen-enriched stream to form an expanded nitrogen-enriched stream;
wherein the volumetric expander is mechanically coupled to the second compression stage so that expansion of the nitrogen-enriched stream provides power to the second compression stage.

8. The system of claim 7, further comprising a heat exchanger in downstream fluid flow communication with the second compression stage and upstream fluid flow communication with the membrane stage, the heat exchanger being adapted to provide indirect heat exchange between the further compressed feed air stream and the expanded nitrogen-enriched stream to form a cooled further compressed feed air stream and a nitrogen-enriched product stream.

9. The system of claim 7, further comprising a flow control valve in downstream fluid flow communication with the nitrogen-enriched stream from the air separation unit and upstream fluid flow communication with the volumetric expander.

10. The system of claim 7, wherein the feed pressure is between 5.0 and 11.0 barg.

11. The system of claim 7, wherein the air separation unit comprises at least one membrane module.

12. The system of claim 7, further comprising at least one filter in downstream fluid flow communication with the first compression stage and upstream fluid flow communication with the second compression stage.
